(19) United States
(12) Patent Application Publication
(10) Pub. No.: US 2022/0052487 A1
(43) Pub. Date: Feb. 17, 2022

(54) ELECTRICAL CONNECTOR ASSEMBLY WITH FOOLPROOF STRUCTURE

(71) Applicant: BELLWETHER ELECTRONIC CORP., Taoyuan City (TW)

(72) Inventor: Chia-yi Chang, Taoyuan City (TW)

(21) Appl. No.: 17/389,352

(22) Filed: Jul. 30, 2021

Related U.S. Application Data
(60) Provisional application No. 63/064,934, filed on Aug. 13, 2020.

(51) Int. Cl. H01R 13/64; H01R 12/73; H01R 13/40; H01R 13/502; H01R 24/60; H01R 13/11

(52) U.S. Cl. CPC H01R 13/64; H01R 12/73; H01R 13/113; H01R 13/502; H01R 24/60; H01R 13/40

(57) ABSTRACT

An electrical connector assembly with a foolproof structure is provided, and includes an electrical connector and a mating electrical connector. The electrical connector includes a main body, a first housing, and a second housing. The first housing has an opening formed thereon, and at least one first foolproof member is formed at an edge of the opening. The mating electrical connector includes a first plugging portion and a second plugging portion that are connected to each other. A socket is formed on one side of the first plugging portion that faces the opening, and at least one second foolproof member is formed on an edge adjacent to the socket. The electrical connector is fixed on a circuit substrate, the socket is plugged in the opening, and the mating electrical connector is mated to the electrical connector.

### CROSS-REFERENCE TO RELATED PATENT APPLICATION

This application claims priority to the U.S. Provisional Patent Application Ser. No. 63/064,934 filed on Aug. 13, 2020, which application is incorporated herein by reference in its entirety.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to an electrical connector assembly, and more particularly to an electrical connector assembly with a foolproof structure.

### BACKGROUND OF THE DISCLOSURE

Electrical connector assemblies can be divided into plug electrical connectors and socket electrical connectors, and the plug electrical connector and the socket electrical connector are electrically connected by mating with each other. However, in existing technologies, an interface of the plug electrical connector and the socket electrical connector used for mating are symmetrical in shape. Therefore, no directional guidance is available when the plug electrical connector and the socket electrical connector mate with each other, which often results in a mating error.

Therefore, how to improve the structural design to overcome the above-mentioned defects has become one of the important issues to be solved in the related art.

### SUMMARY OF THE DISCLOSURE

In response to the above-referenced technical inadequacy, the present disclosure provides an electrical connector assembly with a foolproof structure.

In one aspect, the present disclosure provides an electrical connector assembly with a foolproof structure, and the electrical connector assembly with the foolproof structure includes an electrical connector and a mating electrical connector. The electrical connector includes a main body, a first housing, and a second housing. The first housing has an opening formed thereon, and at least one first foolproof member is formed at an edge of the opening. The mating electrical connector includes a first plugging portion and a second plugging portion that are connected to each other. A socket is formed on one side of the first plugging portion that faces the opening, and at least one second foolproof member is formed on an edge of the first plugging portion adjacent to the socket. The electrical connector is fixed on a circuit substrate, and the socket is plugged in the opening so that the mating electrical connector is mated to the electrical connector. The at least one second foolproof member is engaged with the at least one first foolproof member. The mating electrical connector is mated to an external electrical assembly through the second plugging portion.

In certain embodiments, the mating electrical connector further includes two supporting arms and a plurality of plug terminals, one end of each of the plug terminals forms a second pin and extends from the second plugging portion, the two supporting arms are disposed at two sides of the second pins, and the two supporting arms are electrically connected to at least one grounding portion of the external electrical assembly.

In certain embodiments, the main body includes at least one fixing column, the first housing includes at least one first plugging member, the second housing includes at least one second plugging member, the at least one fixing column is plugged in an at least one hole of the circuit substrate, and the at least one first plugging member and the at least one second plugging member are plugged in a plurality of grounding holes of the circuit substrate.

In certain embodiments, the at least one first foolproof member is a groove, and the at least one second foolproof member is a convex rib.

In certain embodiments, the at least one first foolproof member is a convex rib, and the at least one second foolproof member is a groove.

In another aspect, the present disclosure provides an electrical connector assembly with a foolproof structure, the electrical connector assembly with the foolproof structure includes a board-end electrical connector and a wire-end electrical connector. The board-end electrical connector has an opening. A quantity of at least one first foolproof member is N1, and the at least one first foolproof member is formed at an edge of the opening. N1 is an integer greater than or equal to 1. The wire-end electrical connector is mated to the board-end electrical connector, the wire-end electrical connector further includes a first plugging portion, and a socket is formed on one side of the first plugging portion that faces the opening. A quantity of at least one second foolproof member is N2, and the at least one second foolproof member is formed at an edge adjacent to the socket. N2 is an integer greater than or equal to 1. By adjusting quantities, positions, shapes and sizes of the at least one first foolproof member and the at least one second foolproof member, a mating status of the board-end electrical connector and the wire-end electrical connector is changed.

In certain embodiments, when N1 is equal to N2, the at least one second foolproof member correspond in position to the at least one first foolproof member, and each of the at least one second foolproof members has a shape and a size that matches with a corresponding one of the at least one first foolproof member, such as to enable the board-end electrical connector to successfully dock with the wire-end electrical connector.

In certain embodiments, when N1 is not equal to N2, the at least one second foolproof member does not correspond in position to the at least one first foolproof member, or each of the at least one second foolproof members has a shape and a size that does not match with a corresponding one of the at least one first foolproof member, the board-end electrical connector cannot successfully dock with the wire-end electrical connector.

In certain embodiments, the board-end electrical connector includes a main body, a first housing, and a second housing. The first housing has an opening formed thereon, the first housing is disposed between the second housing and the main body, and the second housing is covered on the main body and the first housing.

In certain embodiments, the main body includes a board structure, the first housing surrounds the board structure, the board structure is plugged in the socket along a plugging direction, a plurality of socket terminals are disposed on an upper surface and a lower surface of the board structure, one end of each of the socket terminals is disposed on the board structure and extends along the plugging direction.

In certain embodiments, the first housing has at least one first chamfered structure, the first plugging portion has at least one second chamfered structure that corresponds to the at least one first chamfered structure, and the at least one first chamfered structure has a same shape as the at least one second chamfered structure.

In certain embodiments, the first foolproof member is a groove or a convex rib, and the second foolproof member is a convex rib or a groove that corresponds to the first foolproof member.

Therefore, by virtue of “the socket being plugged in the opening so that the mating electrical connector is mated to the electrical connector, and the at least one second foolproof member being engaged with the at least one first foolproof member” and “by adjusting quantities, positions, shapes and sizes of the at least one first foolproof member and the at least one second foolproof member, a mating status of the board-end electrical connector and the wire-end electrical connector is changed”, the electrical connector assembly with the foolproof structure of the present disclosure ensures that directional guidance can be provided for the connection between the electrical connector and the mating electrical connector, and reduces an occurrence of an assembly error.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is an exploded view of an electrical connector assembly with a foolproof structure according to a first embodiment of the present disclosure;

FIG. 2 is a perspective view of the electrical connector assembly with the foolproof structure according to the first embodiment of the present disclosure;

FIG. 3 is another perspective view of the electrical connector assembly with the foolproof structure according to the first embodiment of the present disclosure;

FIG. 4 is a perspective view of an electrical connector of the electrical connector assembly with the foolproof structure according to the first embodiment of the present disclosure;

FIG. 5 is another perspective view of the electrical connector of the electrical connector assembly with the foolproof structure according to the first embodiment of the present disclosure;

FIG. 6 is a perspective view of a mating electrical connector of the electrical connector assembly with the foolproof structure according to the first embodiment of the present disclosure;

FIG. 7 is another perspective view of the mating electrical connector of the electrical connector assembly with the foolproof structure according to the first embodiment of the present disclosure;

FIG. 8 is a top view of the electrical connector assembly with the foolproof structure according to the first embodiment of the present disclosure;

FIG. 9 is a top view of the electrical connector assembly with the foolproof structure according to a second embodiment of the present disclosure;

FIG. 10 is a top view of the electrical connector assembly with the foolproof structure according to a third embodiment of the present disclosure; and

FIG. 11 is a top view of the electrical connector assembly with the foolproof structure according to a fourth embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

### First Embodiment

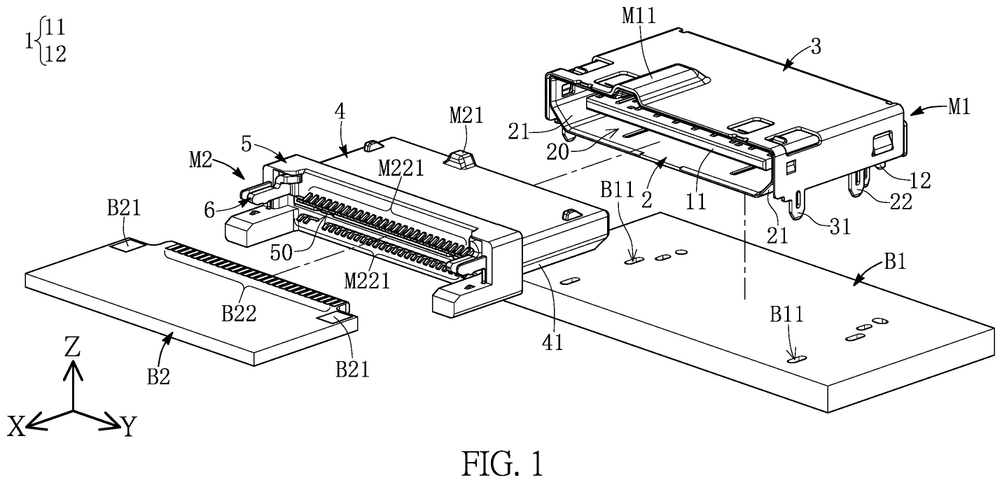

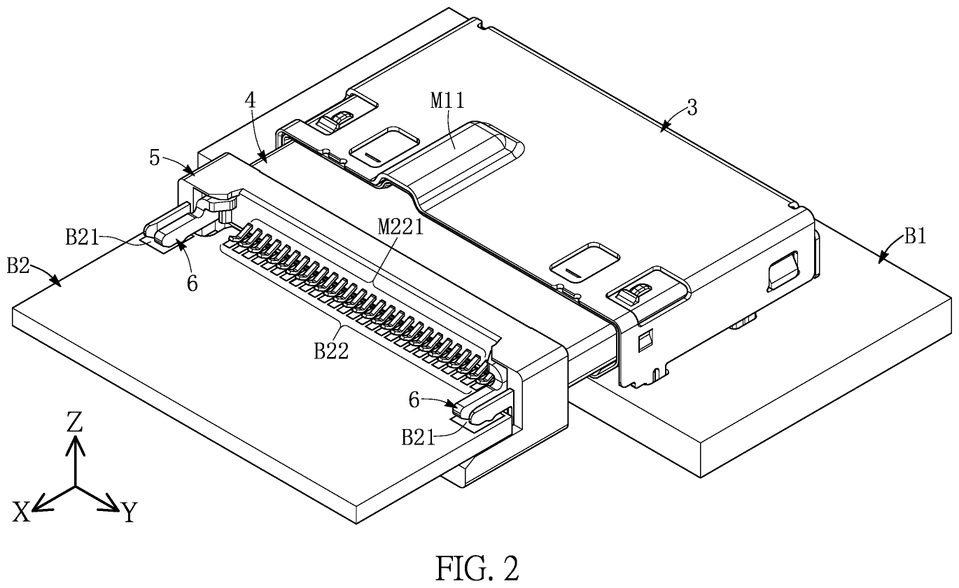

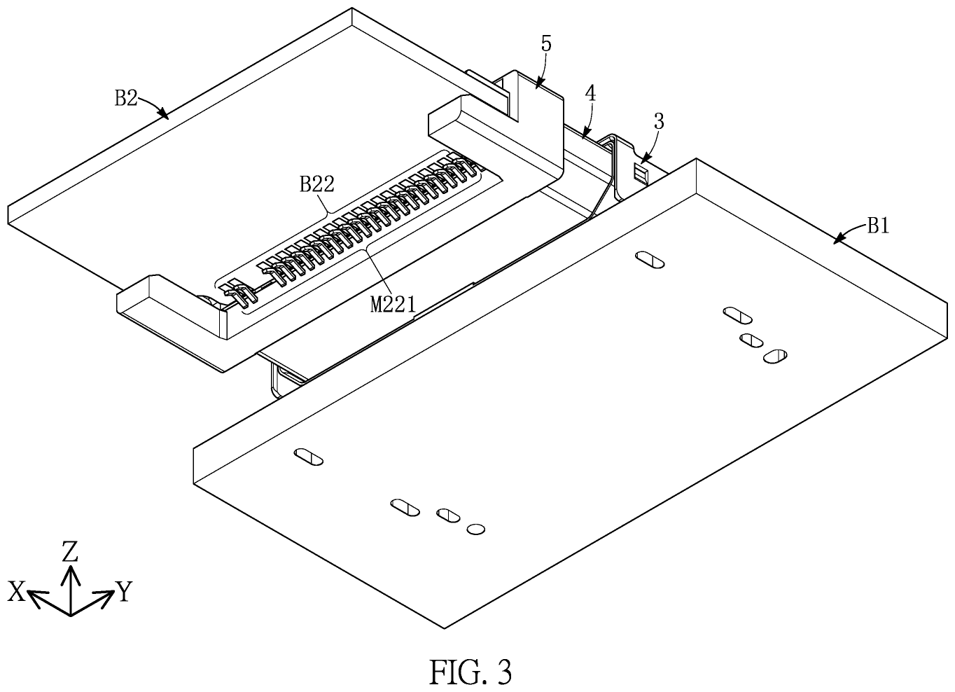

Referring to FIG. 1 to FIG. 3, FIG. 1 is an exploded view of an electrical connector assembly with a foolproof structure according to a first embodiment of the present disclosure, and FIG. 2 and FIG. 3 are perspective views of the electrical connector assembly with the foolproof structure according to the first embodiment of the present disclosure. The first embodiment of the present disclosure provides an electrical connector assembly with a foolproof structure. The electrical connector assembly includes an electrical connector M1 and a mating electrical connector M2. The electrical connector M1 is removably mated to the mating electrical connector M2. For example, the electrical connector M1 of the present disclosure can be a board-end connector, and the mating electrical connector M2 can be a wire-end connector, but the present disclosure is not limited thereto.

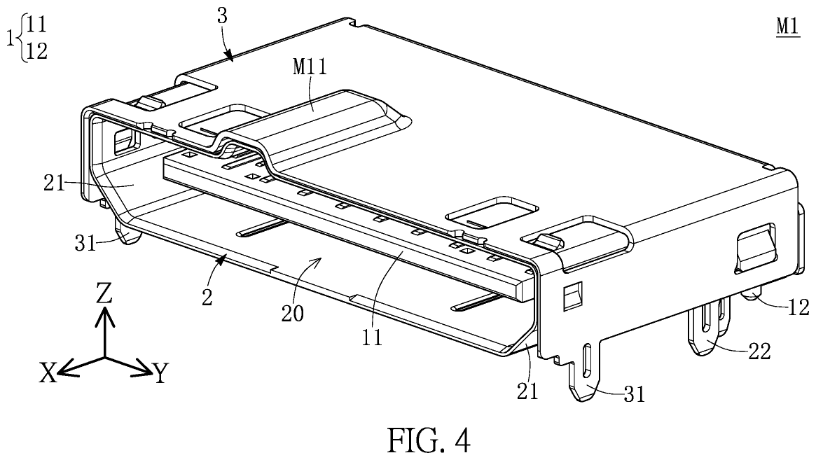

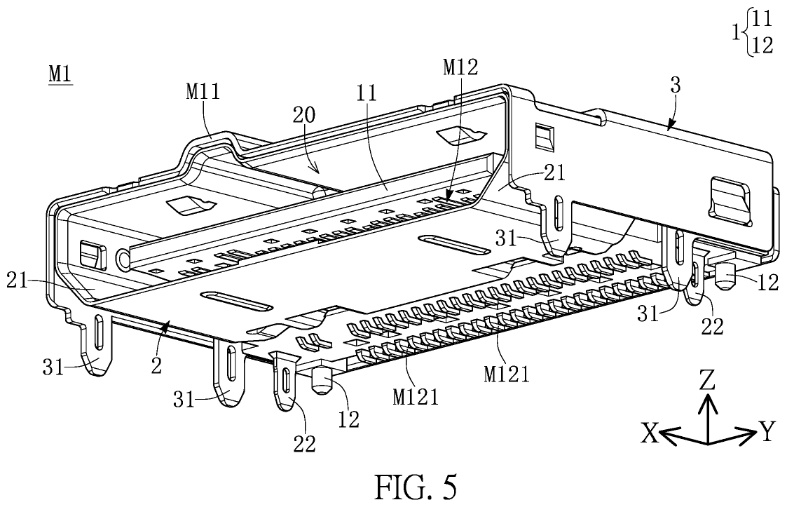

Reference is further made to FIG. 1 to FIG. 3 and to FIG. 4 and FIG. 5, the latter two of which are perspective views of an electrical connector of the electrical connector assembly with the foolproof structure according to the first embodiment of the present disclosure. The electrical connector M1 includes a main body 1, a first housing 2, and a second housing 3. The first housing 2 is disposed between the second housing 3 and the main body 1, the first housing 2 has an opening 20 formed thereon, and at least one first foolproof member M11 is formed at an edge of the opening 20, and the second housing 3 is covered on the main body 1 and the first housing 2, and a corresponding structure is formed on a position on the second housing 3 that corresponds to the first foolproof member M11.

Reference is further made to FIG. 1 to FIG. 5, the main body 1 includes a board structure 11 and at least one fixing column 12, the board structure 11 extends from a side wall of the main body 1, and the at least one fixing column 12 extends from a bottom of the main body 1. An extension direction (a positive X-axis direction) of the board structure 11 is perpendicular to an extension direction (a negative Z-axis direction) of the at least one fixing column 12. When the first housing 2 is disposed between the second housing 3 and the main body 1, the first housing 2 surrounds the board structure 11. That is, the first housing 2 is sleeved on the board structure 11. The electrical connector M1 includes a plurality of socket terminals M12 disposed on the main body 1, one end of each of the socket terminals M12 forms a first pin M121 and is exposed from the bottom of the main body 1 (as shown in FIG. 5), and another end of each of the socket terminals M12 is disposed on the board structure 11 and extends along the extension direction of the board structure 11. Furthermore, the plurality of socket terminals M12 are arranged on an upper surface and a lower surface of the board structure 11, each of the plurality of socket terminals M12 is partially exposed to form a contact portion. The electrical connector M1 is electrically connected to a plurality of soldering pads of a circuit substrate B1 through the plurality of first pins M121 for signal and power transmission. In addition, the first housing 2 has at least one first chamfered structure 21. In the present disclosure, two first chamfered structures 21 are symmetrically formed on opposing sides of a bottom of the first housing 2. In addition, the first housing 2 includes at least one first plugging member 22, and the second housing 3 includes at least one second plugging member 31. Extension directions of the at least one first plugging member 22 and the at least one second plugging member 31 are the same as the extension direction of the at least one fixing column 12 (the negative Z-axis direction). The electrical connector M1 is fixed to the circuit substrate B1 by the at least one fixing column 12, the at least one first plugging member 22, and the at least one second plugging member 31 plugged in a plurality of holes B11 of the circuit substrate B1, so as to strengthen a stability between the electrical connector M1 and the circuit substrate B1. Furthermore, the holes B11 corresponding to the at least one first plugging member 22 (and the at least one second plugging member 31) are grounding holes (that is, the holes B11 plugged by the at least one first plugging member 22 and the at least one second plugging member 31 are grounding holes), so that the first housing 2 (and the second housing 3) can provide a shielding effect.

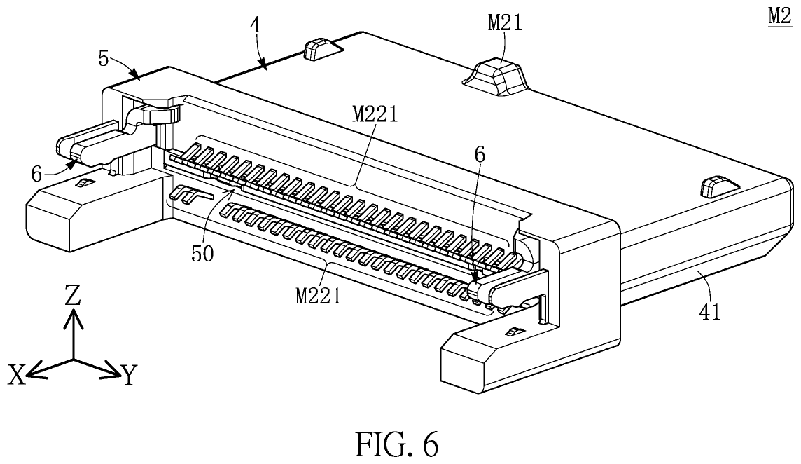

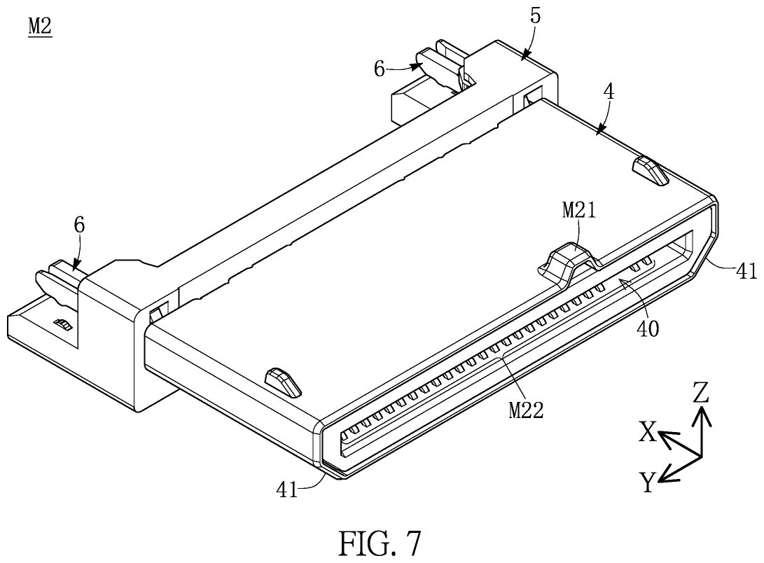

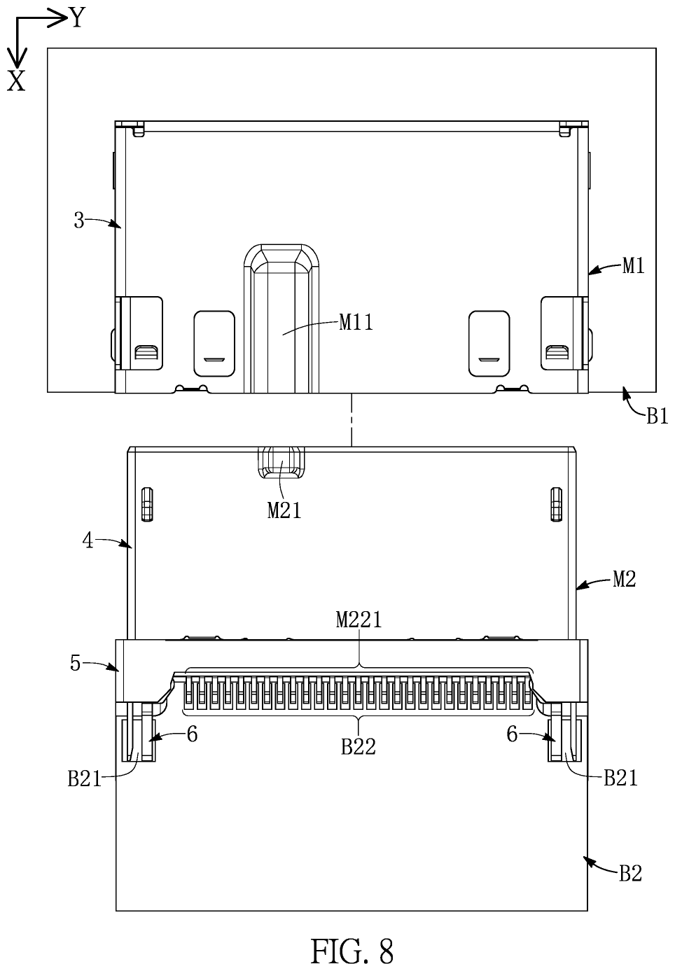

Reference is further made to FIG. 1 to FIG. 3, in conjunction with FIG. 6 to FIG. 8. FIG. 6 and FIG. 7 are perspective views of a mating electrical connector of the electrical connector assembly with the foolproof structure according to the first embodiment of the present disclosure, and FIG. 8 is a top view of the electrical connector assembly with the foolproof structure according to the first embodiment of the present disclosure. The mating electrical connector M2 includes a first plugging portion 4 and a second plugging portion 5 that are connected to each other, a socket 40 is formed on one side of the first plugging portion 4 that faces the opening 20, and at least one second foolproof member M21 is formed on an edge of the first plugging portion 4 adjacent to the socket 40. The mating electrical connector M2 is mated to an external electrical assembly B2 through the second plugging portion 5. The first plugging portion 4 has at least one second chamfered structure 41 that corresponds to the at least one first chamfered structure 21, and the at least one first chamfered structure 21 has a same shape as the at least one second chamfered structure 41. In the present disclosure, two second chamfered structures 41 are symmetrically formed on opposing sides of a bottom of the first plugging portion 4. The mating electrical connector M2 includes a plurality of plug terminals M22, one end of each of the plug terminals M22 forms a second pin M221 and extends from the second plugging portion 5, and the plurality of second pins M221 are arranged in two rows, i.e., an upper row and a lower row, to form an interface 50. The other end of each of the plug terminals M22 are arranged on the socket 40 and extends along an extension direction of the socket 40 (a negative X-axis direction). Furthermore, an upper side and a lower side of the socket 40 each have a plurality of plug terminals M22, and each of the plug terminals M22 is partially exposed to form a contact portion. The external electrical assembly B2 can be plugged in the interface 50 so that the mating electrical connector M2 is electrically connected to the external electronic assembly B2. In addition, the mating electrical connector M2 also includes two supporting arms 6 that are disposed on the second plugging portion 5 and are respectively located on two opposite sides of the plurality of second pins M221. When the mating electrical connector M2 is electrically connected to the external electronic assembly B2, the two supporting arms 6 are electrically connected to at least one grounding portion B21 of the external electronic assembly B2 and are grounded. In addition, when the external electronic assembly B2 is plugged in the interface 50, a plurality of terminal transformation portions B22 of the external electronic assembly B2 are in electrical contact with the plurality of second pins M221, respectively, so that the external electronic assembly B2 (or a cable connected to the external electronic assembly B2) electrically connects to the mating electrical connector M2 of the present disclosure and performs signal transmission.

As described above, when the mating electrical connector M2 is mated to the electrical connector M1, the mating electrical connector M2 is mated to the electrical connector M1 through the socket 40 plugged in the opening 20, and the at least one second foolproof member M21 is engaged in the at least one first foolproof member M11. At this time, the board structure 11 is plugged in the socket 40 along an insertion direction (the insertion direction is the same as the extension direction of the board structure 11, and both are positive X-axis directions), and the plurality of socket terminals M12 are in physical contact with the plurality of plug terminals M22 in the socket 40, so that the mating electrical connector M2 is electrically connected to the electrical connector M1. Furthermore, when the plurality of socket terminals M12 are in physical contact with the plurality of plug terminals M22 in the socket 40, each of the socket terminals M12 is in physical contact with a contact region on each of the plug terminals M22 through a contact zone on each of the socket terminals M12 (not shown in the figures), respectively.

In this embodiment, the at least one first foolproof member M11 is a groove and the at least one second foolproof member M21 is a convex rib. In detail, the at least one first foolproof member M11 is a groove formed through a top wall of the first housing 2 protruding upward (outward), and the corresponding structure formed on the second housing 3 is also a groove formed through a top wall of the second housing 3 protruding upward (outward). That is, the groove formed on the first housing 2 overlaps with the groove formed on the second housing 3. In addition, it should be noted that the present disclosure is not limited to a type, shape, size and quantity of the first foolproof member M11 and the second foolproof member M21. That is, in other embodiments, the at least one first foolproof member M11 can be a convex rib and the at least one second foolproof member M21 can be a groove.

### Second Embodiment

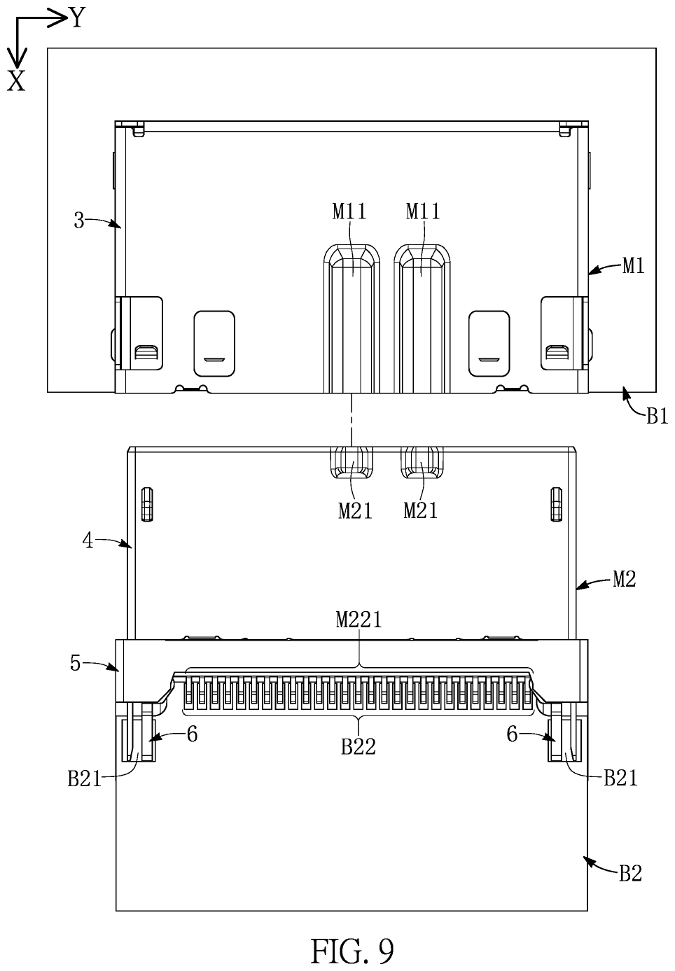

Referring to FIG. 9, FIG. 9 is a top view of the electrical connector assembly with the foolproof structure according to a second embodiment of the present disclosure. Comparing FIG. 9 and FIG. 8, one of the differences between the second embodiment and the first embodiment is that the quantities of the first foolproof member M11 and the second foolproof member M21 are different. In the first embodiment, the quantities of the first foolproof member M11 and the second foolproof member M21 are respectively one. In this embodiment, the quantities of the first foolproof member M11 and the second foolproof member M21 are respectively two. The present disclosure is not limited to a distance between the two first foolproof members M11, and is not limited to a distance between the two second foolproof members M21, however, it should be noted that a distance between the two first foolproof members M11 is equal to a distance between the two second foolproof members M21. Furthermore, a position of any one of the two first foolproof members M11 of the second embodiment is different from a position of the first foolproof member M11 of the first embodiment. Therefore, the mating electrical connector M2 of the second embodiment cannot dock with the electrical connector M1 of the first embodiment, and the mating electrical connector M2 of the first embodiment cannot dock with the electrical connector M1 of the second embodiment. In addition, it should be noted that other components of the electrical connector assembly provided in the second embodiment are the same as that of the aforementioned first embodiment, and are not reiterated herein.

### Third Embodiment

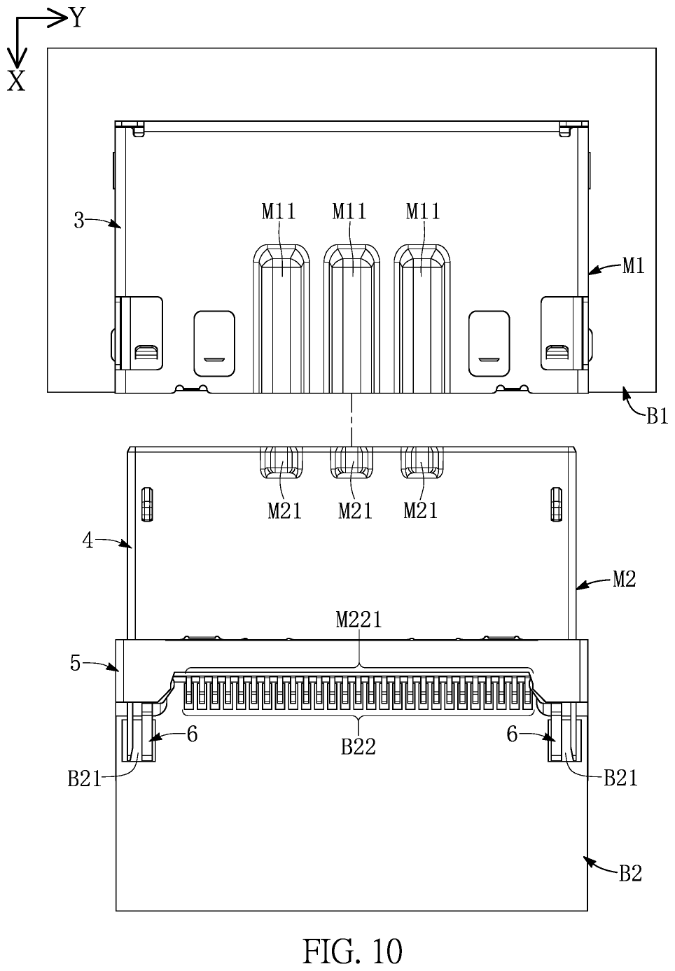

Referring to FIG. 10, FIG. 10 is a top view of the electrical connector assembly with the foolproof structure according to a third embodiment of the present disclosure. Comparing FIG. 10 and FIG. 8, one of the differences between the third embodiment and the first embodiment is that the quantities of the first foolproof member M11 and the second foolproof member M21 are different. In this embodiment, the quantities of the first foolproof member M11 and the second foolproof member M21 are respectively three. The present disclosure is not limited to a distance between two adjacent ones of the three first foolproof members M11, and is not limited to a distance between two adjacent ones of the three second foolproof members M21. However, it should be noted that distances between two adjacent first foolproof members M11 are respectively equal to corresponding distances between two adjacent second foolproof members M21. Furthermore, a width of any one of the first foolproof members M11 of the third embodiment is different from a width of the first foolproof member M11 of the first embodiment and a width of any one of the first foolproof members M11 of the second embodiment. Therefore, the mating electrical connector M2 of the third embodiment cannot dock with the electrical connector M1 of the first and second embodiment, and the electrical connector M1 of the third embodiment cannot dock with the mating electrical connector M2 of the first and second embodiment. On the other hand, position(s) of the first foolproof member(s) M11 of the embodiment having less of the first foolproof members M11 is different from a position of any one foolproof member M11 of the embodiment having more of the first foolproof members M11, so that a mating error can be avoided.

In addition, it should be noted that other components of the electrical connector assembly provided in the third embodiment are the same as that of the aforementioned first embodiment, and are not reiterated herein.

### Fourth Embodiment

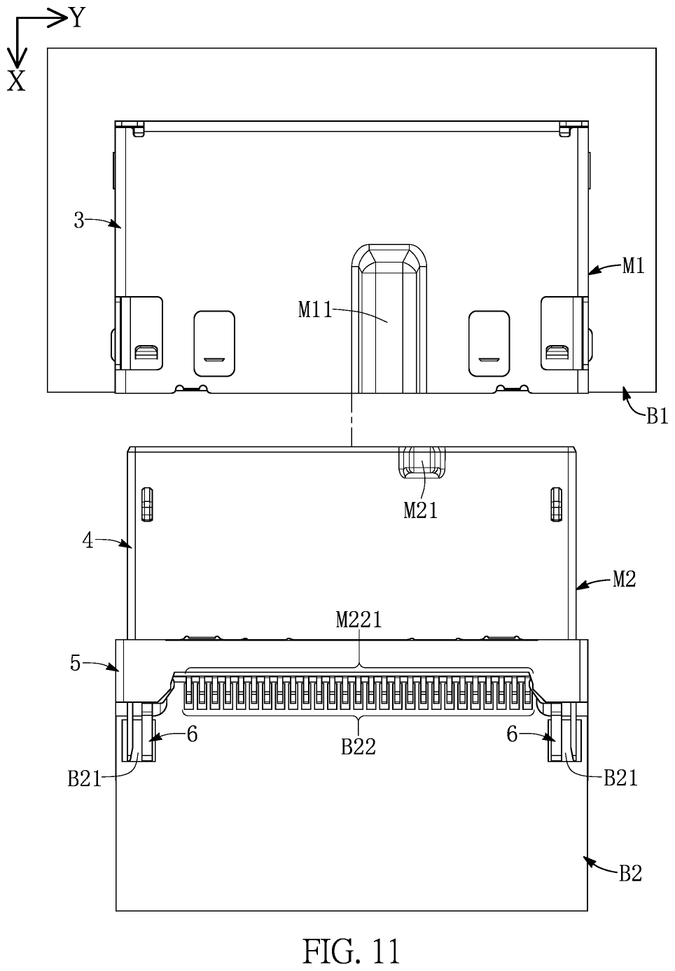

Referring to FIG. 11, FIG. 11 is a top view of the electrical connector assembly with the foolproof structure according to a fourth embodiment of the present disclosure. Comparing FIG. 11 and FIG. 8, one of the differences between the fourth embodiment and the first embodiment is that the positions of the first foolproof member M11 and the second foolproof member M21 are different. In this embodiment, the quantities of the first foolproof member M11 and the second foolproof member M21 are respectively one. Furthermore, the position of the first foolproof member M11 of the fourth embodiment is different from the position of any one of the first foolproof members M11 of the first and second embodiment, and a width of the first foolproof member M11 of the fourth embodiment is greater than a width of any one of the first foolproof members M11 of the third embodiment. Therefore, the electrical connector M1 and the mating electrical connector M2 of the fourth embodiment cannot dock with the mating electrical connectors M2 and the electrical connectors M1 of the three aforementioned embodiments. In addition, it should be noted that other components of the electrical connector assembly provided in the fourth embodiment are the same as that of the aforementioned first embodiment, and are not reiterated herein.

The socket terminals M12 and the plug terminals M22 of the aforementioned embodiments can have different pin definitions. Through differences in positions, quantities, or sizes (widths), the electrical connector M1 of each embodiment can only be mated with the corresponding mating electrical connector M2, and cannot be mated with the mating electrical connector M2 from a different embodiment. For example, when two electrical connector assemblies have the substantially same appearance (that is, having the openings 20 that have the same length and width, and even having the same first chamfered structures 21), a first electrical connector assembly has at least one first foolproof member, a quantity of the at least one first foolproof member of the first electrical connector assembly is N1, and a second electrical connector assembly has at least one first foolproof member, a quantity of the at least one first foolproof member of the second electrical connector assembly is N2. A position of at least one of N1 first foolproof members is different from a position of any one of N2 first foolproof members, or a width of at least one of the N1 first foolproof members is greater than a width of at least one of the N2 first foolproof members. N1 is an integer greater than or equal to 1, and N2 is an integer greater than or equal to N1.

### Beneficial Effects of the Embodiments

In conclusion, by virtue of “the socket 40 being plugged in the opening 20 so that the mating electrical connector M2 is mated to the electrical connector M1, and the at least one second foolproof member M21 being engaged with the at least one first foolproof member M11”, the electrical connector assembly with the foolproof structure of the present disclosure ensures that directional guidance can be provided for the connection between the electrical connector M1 and the mating electrical connector M2, and reduces an occurrence of a mating error.

Furthermore, in the present disclosure, two first chamfered structures 21 are symmetrically formed on opposing sides of the bottom of the first housing 2 of the electrical connector M1, two second chamfered structures 41 are formed on the first plugging portion 4 of the mating electrical connector M2 and correspond to the two first chamfered structures 21, and the two first chamfered structures 21 have the same shape as the two second chamfered structures 41, further ensuring that directional guidance is provided when the electrical connector M1 docks with the mating electrical connector M2.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated.

Alternative embodiments will become apparent to those skilled in the art to which the present disclosure pertains without departing from its spirit and scope.

What is claimed is:

1. An electrical connector assembly with a foolproof structure, comprising:
an electrical connector including a main body, a first housing, and a second housing, wherein the first housing is disposed between the second housing and the main body, the first housing has an opening formed thereon, and at least one first foolproof member is formed at an edge of the opening, and the second housing is covered on the main body and the first housing; and
a mating electrical connector configured to be mated to the electrical connector, wherein the mating electrical connector includes a first plugging portion and a second plugging portion that are connected to each other, a socket is formed on one side of the first plugging portion that faces the opening, and at least one second foolproof member is formed on an edge of the first plugging portion adjacent to the socket;
wherein the electrical connector is fixed on a circuit substrate, the socket is plugged in the opening so that the mating electrical connector is mated to the electrical connector, the at least one second foolproof member is engaged with the at least one first foolproof member, and the mating electrical connector is mated to an external electrical assembly through the second plugging portion.

2. The electrical connector assembly according to claim 1, wherein the mating electrical connector further includes two supporting arms and a plurality of plug terminals, wherein one end of each of the plug terminals forms a second pin and extends from the second plugging portion, the two supporting arms are disposed at two sides of the second pins, and the two supporting arms are electrically connected to at least one grounding portion of the external electrical assembly.

3. The electrical connector assembly according to claim 1, wherein the main body includes at least one fixing column, the first housing includes at least one first plugging member, the second housing includes at least one second plugging member, the at least one fixing column is plugged in an at least one hole of the circuit substrate, and the at least one first plugging member and the at least one second plugging member are plugged in a plurality of grounding holes of the circuit substrate.

4. The electrical connector assembly according to claim 1, wherein the at least one first foolproof member is a groove, and the at least one second foolproof member is a convex rib.

5. The electrical connector assembly according to claim 1, wherein the at least one first foolproof member is a convex rib, and the at least one second foolproof member is a groove.

6. The electrical connector assembly according to claim 1, wherein the main body includes a board structure, the first housing surrounds the board structure, the board structure is plugged in the socket along a plugging direction, a plurality of socket terminals are disposed on an upper surface and a lower surface of the board structure, and one end of each of the socket terminals is disposed on the board structure and extends along the plugging direction.

7. An electrical connector assembly with a foolproof structure, comprising:
a board-end electrical connector having an opening, a quantity of at least one first foolproof member being N1, and the at least one first foolproof member being formed at an edge of the opening, wherein N1 is an integer greater than or equal to 1; and
a wire-end electrical connector for being mated to the board-end electrical connector, the wire-end electrical connector further including a first plugging portion, a socket being formed on one side of the first plugging portion that faces the opening, a quantity of at least one second foolproof member being N2, and the at least one second foolproof member being formed at an edge adjacent to the socket, wherein N2 is an integer greater than or equal to 1;
wherein, by adjusting quantities, positions, shapes and sizes of the at least one first foolproof member and the at least one second foolproof member, a mating status of the board-end electrical connector and the wire-end electrical connector is changed.

8. The electrical connector assembly according to claim 7, wherein, when N1 is equal to N2, the at least one second foolproof member correspond in position to the at least one first foolproof member, and each of the at least one second foolproof members has a shape and a size that matches with a corresponding one of the at least one first foolproof member, such as to enable the board-end electrical connector to successfully dock with the wire-end electrical connector.

9. The electrical connector assembly according to claim 8, wherein the board-end electrical connector includes a main body, a first housing, and a second housing, the first housing has an opening formed thereon, and wherein the first housing is disposed between the second housing and the main body, and the second housing is covered on the main body and the first housing.

10. The electrical connector assembly according to claim 9, wherein the main body includes a board structure, the first housing surrounds the board structure, the board structure is plugged in the socket along a plugging direction, a plurality of socket terminals are disposed on an upper surface and a lower surface of the board structure, and one end of each of the socket terminals is disposed on the board structure and extends along the plugging direction.

11. The electrical connector assembly according to claim 9, wherein the first housing has at least one first chamfered structure, the first plugging portion has at least one second chamfered structure that corresponds to the at least one first chamfered structure, and the at least one first chamfered structure has a same shape as the at least one second chamfered structure.

12. The electrical connector assembly according to claim 8, wherein the first foolproof member is a groove or a convex rib, and the second foolproof member is a convex rib or a groove that corresponds to the first foolproof member.

13. The electrical connector assembly according to claim 7, wherein, when N1 is not equal to N2, the at least one second foolproof member does not correspond in position to the at least one first foolproof member, or each of the at least one second foolproof members has a shape and a size that does not match with a corresponding one of the at least one first foolproof member, the board-end electrical connector cannot successfully dock with the wire-end electrical connector.

14. The electrical connector assembly according to claim 13, wherein the board-end electrical connector includes a main body, a first housing, and a second housing, the first housing has an opening formed thereon, and wherein the first housing is disposed between the second housing and the main body, and the second housing is covered on the main body and the first housing.

15. The electrical connector assembly according to claim 14, wherein the main body includes a board structure, the first housing surrounds the board structure, the board structure is plugged in the socket along a plugging direction, a plurality of socket terminals are disposed on an upper surface and a lower surface of the board structure, one end of each of the socket terminals is disposed on the board structure and extends along the plugging direction.

16. The electrical connector assembly according to claim 14, wherein the first housing has at least one first chamfered structure, the first plugging portion has at least one second chamfered structure that corresponds to the at least one first chamfered structure, and the at least one first chamfered structure has a same shape as the at least one second chamfered structure.

17. The electrical connector assembly according to claim 13, wherein the first foolproof member is a groove or a convex rib, and the second foolproof member is a convex rib or a groove that corresponds to the first foolproof member.
